(19) United States
(12) Patent Application Publication
(10) Pub. No.: US 2023/0412244 A1
(43) Pub. Date: Dec. 21, 2023

(54) RECEIVING APPARATUS, TRANSMITTING APPARATUS, CONTROL CIRCUIT, STORAGE MEDIUM, RECEPTION METHOD, AND TRANSMISSION METHOD

(71) Applicant: Mitsubishi Electric Corporation, Tokyo (JP)

(72) Inventors: Akinori NAKAJIMA, Tokyo (JP); Masatsugu HIGASHINAKA, Tokyo (JP)

(73) Assignee: Mitsubishi Electric Corporation, Tokyo (JP)

(21) Appl. No.: 18/239,818

(22) Filed: Aug. 30, 2023

Related U.S. Application Data
(63) Continuation of application No. PCT/JP2021/015342, filed on Apr. 13, 2021.

(51) Int. Cl. H04B 7/08; H04L 27/14

(52) U.S. Cl. CPC H04B 7/0857; H04L 27/14

(57) ABSTRACT

A receiving apparatus that receives a signal modulated by a frequency modulation scheme, using a plurality of receiving antennas includes an FSK modulation-compatible interference extraction unit that extracts, from a plurality of reception signals received by the plurality of receiving antennas, interference signals that are frequency components other than frequency components of desired signals at which power is concentrated, a complex weight calculator that calculates a complex weight of each reception signal, on the basis of the same number of the interference signals as the number of the receiving antennas, and a complex weight multiplication and combining unit that multiplies each of the plurality of reception signals by the corresponding complex weight, and combines the reception signals that have been multiplied by the complex weights.

### CROSS-REFERENCE TO RELATED APPLICATION

This application is a continuation application of International Application PCT/JP2021/015342, filed on Apr. 13, 2021, and designating the U.S., the entire contents of which are incorporated herein by reference.

### BACKGROUND OF THE INVENTION

### 1. Field of the Invention

The present disclosure relates to a receiving apparatus, a transmitting apparatus, a control circuit, a storage medium, a reception method, and a transmission method using a frequency modulation scheme.

### 2. Description of the Related Art

Assume a wireless communication system in which data is transmitted and received between a plurality of transmitting apparatuses each having at least one transmitting antenna and at least one receiving apparatus having at least two receiving antennas. To minimize frequencies used from the standpoint of frequency utilization efficiency, for example, this wireless communication system is formed in a frequency repetition configuration in which cells using the same frequency are physically separated from each other for repeated use. Alternatively, the wireless communication system is formed in a single frequency network (SFN) configuration in which a plurality of transmitting apparatuses such as base stations transmit the same data at the same time, using the same frequency. To construct the wireless communication system, the system is basically designed so as not to generate intra-system interference. In practice, however, a receiving apparatus may receive a transmission signal from a remote transmitting apparatus because of the influence of station placement conditions, geographical features, etc. If the transmission signal from the remote transmitting apparatus has the same frequency as that received by the receiving apparatus, intra-system interference occurs. In this case, the wireless communication system of the frequency repetition configuration degrades reception performance because different signals are received in a multiplexed manner. For the wireless communication system of the SFN configuration, the same signal is received with delay, so that reception performance is greatly degraded.

An adaptive array is known as a technique that reduces the above interference influence. A receiving apparatus including an adaptive array uses a plurality of receiving antennas, multiplies a plurality of reception signals obtained from the receiving antennas by the corresponding complex weights, and then combines the plurality of reception signals that have been multiplied by the complex weights. Consequently, the receiving apparatus including the adaptive array can reduce the influence of interference signals, and can improve signal power to interference and noise power. For complex weight calculation, a method based on channel estimate values obtained from a known sequence or the like, a blind method that applies a least mean square (LMS) algorithm or the like to sequentially update complex weights to minimize the error, etc. are known. Japanese Patent No. 6526348 discloses a technique that applies an adaptive array while reducing radio resource consumption for narrowband transmission. Specifically, a receiving apparatus of Japanese Patent No. 6526348 performs channel estimation on desired signals, using known signals received, and generates a known signal replica using obtained channel estimate values. The receiving apparatus of Japanese Patent No. 6526348 subtracts the known signal replica from the received known signals to extract interference signals, and calculates complex weights from the extracted interference signals.

For a narrowband wireless communication system using a frequency modulation scheme (frequency-shift keying (FSK)), coverage per transmitting apparatus is so expanded that a receiving apparatus can be more greatly affected by interference signals from a remote transmitting apparatus than at the time of phase modulation. For this reason, the application of an adaptive array is effective. Unfortunately, the above conventional technique poses a problem of degradation of interference extraction accuracy as the channel estimation accuracy degrades with the increase in the moving speed of a receiving apparatus. The complex weight calculation accuracy degrades accordingly.

The present disclosure has been made in view of the above.

### SUMMARY OF THE INVENTION

To solve the above problem and achieve the object, the present disclosure provides a receiving apparatus to receive a signal modulated by a frequency modulation scheme, using a plurality of receiving antennas. The receiving apparatus comprises: an interference extraction unit to extract, from a plurality of reception signals received by the plurality of receiving antennas, interference signals that are frequency components other than frequency components of desired signals at which power is concentrated; a complex weight calculator to calculate a complex weight of each reception signal, on a basis of the same number of the interference signals as the number of the receiving antennas; and a complex weight multiplication and combining unit to multiply each of the plurality of reception signals by the corresponding complex weight, and combine the reception signals that have been multiplied by the complex weights.

### BRIEF DESCRIPTION OF THE DRAWINGS

FIG. 1 is a diagram illustrating an example of a frame format used in wireless communication using FSK modulation according to a first embodiment;

FIG. 2 is a block diagram illustrating an example configuration of a transmitting apparatus according to the first embodiment;

FIG. 3 is a flowchart illustrating an operation of the transmitting apparatus according to the first embodiment;

FIG. 4 is a block diagram illustrating an example configuration of a receiving apparatus according to the first embodiment;

FIG. 5 is a flowchart illustrating an operation of the receiving apparatus according to the first embodiment;

FIG. 6 is a block diagram illustrating an example configuration of an FSK modulation-compatible interference extraction unit included in a demodulator of the receiving apparatus according to the first embodiment;

FIG. 7 is a diagram illustrating an image of an operation to extract interference signals in FSK modulation interference signal extraction units of the receiving apparatus according to the first embodiment;

FIG. 8 is a first block diagram illustrating an example configuration of a receiving apparatus that extracts interference signals, taking delayed waves into consideration in the first embodiment;

FIG. 9 is a second block diagram illustrating an example configuration of the receiving apparatus that extracts interference signals, taking delayed waves into consideration in the first embodiment;

FIG. 10 is a diagram illustrating an example configuration of processing circuitry when a processor and memory implement processing circuitry included in the transmitting apparatus according to the first embodiment;

FIG. 11 is a diagram illustrating an example of processing circuitry when dedicated hardware constitutes the processing circuitry included in the transmitting apparatus according to the first embodiment;

FIG. 12 is a block diagram illustrating an example configuration of a transmitting apparatus according to a second embodiment;

FIG. 13 is a block diagram illustrating an example configuration of a receiving apparatus according to the second embodiment;

FIG. 14 is a diagram illustrating an example of signals transmitted from a transmitting apparatus that performs space-time block code (STBC) encoding and FSK modulation without using a characteristic known sequence in the second embodiment, and signals received by a receiving apparatus as a comparative example;

FIG. 15 is a diagram illustrating an example of signals transmitted from the transmitting apparatus and signals received by the receiving apparatus according to the second embodiment;

FIG. 16 is a diagram illustrating an example of a known sequence intended to superimpose desired signals on the same frequencies in an STBC block so as to avoid superimposition of delayed waves on the desired signals outside the STBC block in a third embodiment;

FIG. 17 is a block diagram illustrating an example configuration of a receiving apparatus according to a fourth embodiment;

FIG. 18 is a block diagram illustrating an example configuration of an STBC inverse modulation and interference extraction unit included in a demodulator of the receiving apparatus according to the fourth embodiment;

FIG. 19 is a first block diagram illustrating an example configuration of a receiving apparatus according to a fifth embodiment; and

FIG. 20 is a second block diagram illustrating an example configuration of a receiving apparatus according to the fifth embodiment.

### DETAILED DESCRIPTION OF THE PREFERRED EMBODIMENTS

A receiving apparatus, a transmitting apparatus, a control circuit, a storage medium, a reception method, and a transmission method according to embodiments of the present disclosure will be hereinafter described in detail with reference to the drawings.

### First Embodiment

A first embodiment describes a method of efficiently extracting interference components, that is, interference signals from reception signals when FSK modulation is employed in narrowband transmission. FSK modulation provides signal power with a property of appearing at a specific frequency when one symbol is converted in a frequency domain. The first embodiment utilizes that property of signal power to allow a receiving apparatus to extract frequency components except desired signals whose power is concentrated at specific frequencies. Consequently, the receiving apparatus can easily and efficiently extract interference signals without the need to perform channel estimation, and thus achieve a highly accurate adaptive array. Note that a narrow band in narrowband transmission is defined as a term used relative to a high band. As the bandwidth of typical wireless local area networks (LANs) is on the order of 20 MHz, the narrow band is a bandwidth of about 2 MHz or less, which is one-tenth of the bandwidth of wireless LANs. That is, the narrow band is some MHz or less. However, the following description is not based on the assumption that the bandwidth is limited to about 2 MHz or less.

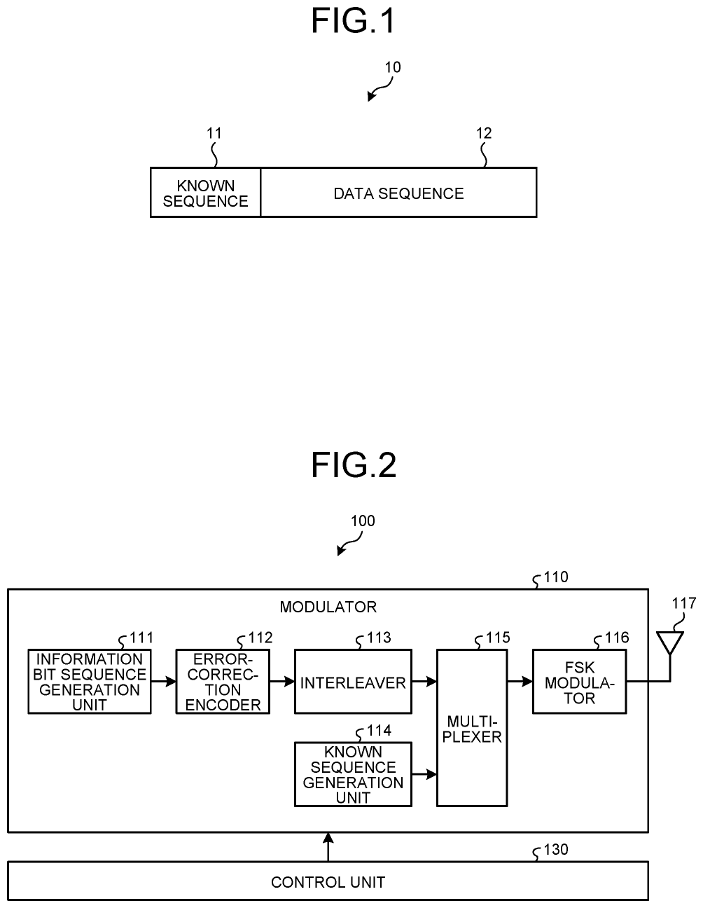

FIG. 1 is a diagram illustrating an example of a format of a frame 10 used in wireless communication using FSK modulation according to the first embodiment. The frame 10 is made up of a known sequence 11 and a data sequence 12. For the frame 10, the known sequence 11 for synchronization or channel estimation is joined to a preceding part of the data sequence 12 that has been FSK-modulated. The known sequence 11 as used herein has also undergone FSK modulation.

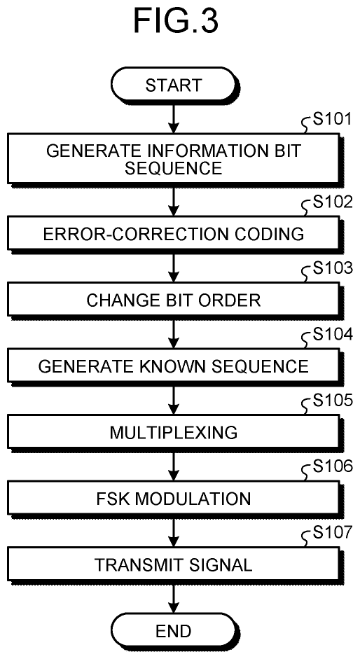

FIG. 2 is a block diagram illustrating an example configuration of a transmitting apparatus 100 according to the first embodiment. The transmitting apparatus 100 includes a modulator 110, a transmitting antenna 117, and a control unit 130. The modulator 110 includes an information bit sequence generation unit 111, an error-correction encoder 112, an interleaver 113, a known sequence generation unit 114, a multiplexer 115, and an FSK modulator 116. In the following description, the FSK modulator 116 is sometimes simply referred to as a modulator. FIG. 3 is a flowchart illustrating an operation of the transmitting apparatus 100 according to the first embodiment.

The information bit sequence generation unit 111 generates an information bit sequence (step S101) and outputs the information bit sequence to the error-correction encoder 112. The information bit sequence generation unit 111 may include a storage unit and read and output an information bit sequence stored in the storage unit, or may output an information bit sequence acquired from the outside. The error-correction encoder 112 performs error-correction coding processing on the information bit sequence acquired from the information bit sequence generation unit 111 (step S102), and outputs, to the interleaver 113, the encoded bit sequence that has undergone the error-correction coding processing. For the encoded bit sequence acquired from the error-correction encoder 112, the interleaver 113 changes the order of bits defining the encoded bit sequence (step S103), and outputs, to the multiplexer 115, the data sequence 12 that is the bit sequence having the order changed.

The known sequence generation unit 114 generates the known sequence 11 (step S104) and outputs the known sequence 11 to the multiplexer 115. The known sequence generation unit 114 may include a storage unit and read and output the known sequence 11 stored in the storage unit, or may output the known sequence 11 acquired from the outside. The multiplexer 115 multiplexes the data sequence 12 acquired from the interleaver 113 and the known sequence 11 acquired from the known sequence generation unit 114 (step S105), and outputs, to the FSK modulator 116, a multiplexed bit sequence that is a signal obtained by multiplexing the data sequence 12 and the known sequence 11. The FSK modulator 116 applies FSK modulation to the multiplexed bit sequence acquired from the multiplexer 115 (step S106), and transmits the FSK-modulated signal from the transmitting antenna 117 (step S107). The control unit 130 controls the operation of the modulator 110, that is, the operation of each unit included in the modulator 110.

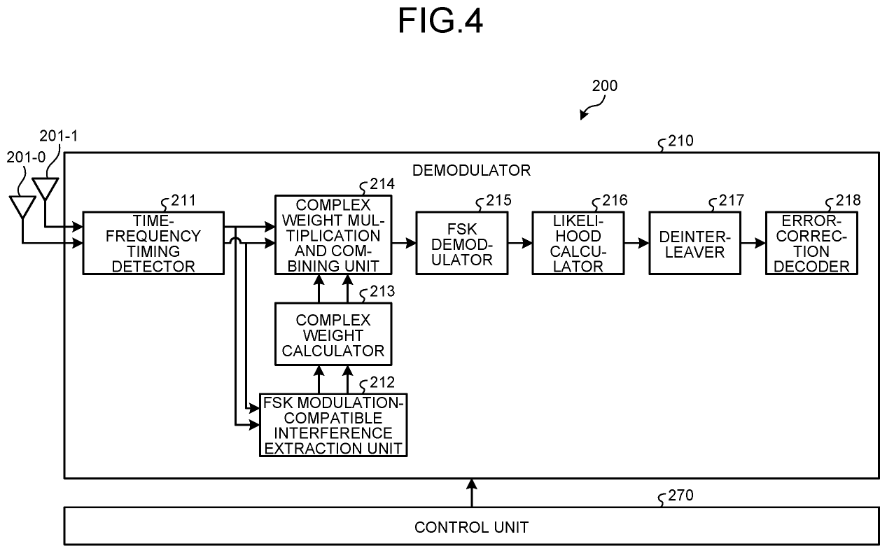

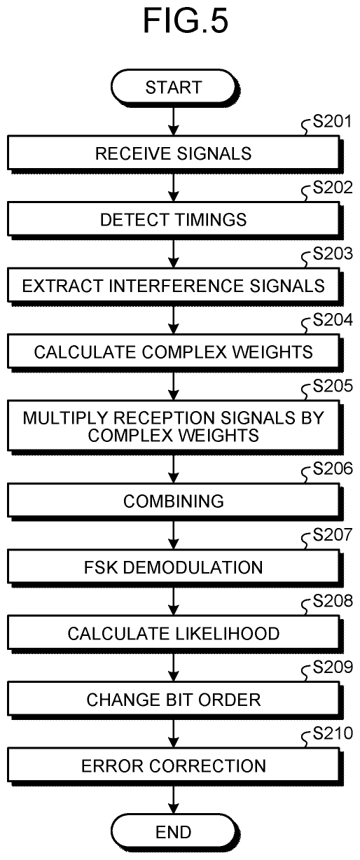

FIG. 4 is a block diagram illustrating an example configuration of a receiving apparatus 200 according to the first embodiment. The receiving apparatus 200 includes receiving antennas 201-0 and 201-1, a demodulator 210, and a control unit 270. The demodulator 210 includes a time-frequency timing detector 211, an FSK modulation-compatible interference extraction unit 212, a complex weight calculator 213, a complex weight multiplication and combining unit 214, an FSK demodulator 215, a likelihood calculator 216, a deinterleaver 217, and an error-correction decoder 218. In the following description, the receiving antennas 201-0 and 201-1 are sometimes referred to as receiving antennas 201 when not distinguished from each other. The receiving antennas 201 will be described by way of example as including the two receiving antennas 201 defining a minimum configuration for applying an adaptive array. The plurality of receiving antennas 201 of the receiving apparatus 200 receives a signal FSK-modulated by the transmitting apparatus 100. FIG. 5 is a flowchart illustrating an operation of the receiving apparatus 200 according to the first embodiment.

The receiving antennas 201-0 and 201-1 receive a signal transmitted from the transmitting apparatus 100 (step S201). The time-frequency timing detector 211 performs time and frequency timing detection on reception signals received by the receiving antennas 201-0 and 201-1, using the known sequence 11 (step S202). For adaptive array processing, the FSK modulation-compatible interference extraction unit 212 extracts interference signals from the reception signals whose time and frequency timings have been detected by the time-frequency timing detector 211 (step S203). The FSK modulation-compatible interference extraction unit 212 is an interference extraction unit that extracts, from the reception signals, interference signals that are frequency components other than frequency components of desired signals at which power is concentrated. The complex weight calculator 213 calculates complex weights corresponding to the two reception signal lines, on the basis of the interference signals obtained by the FSK modulation-compatible interference extraction unit 212 (step S204). The complex weights corresponding to the two reception signal lines are complex weights corresponding to the reception signals received by the receiving antennas 201-0 and 201-1. That is, the complex weight calculator 213 calculates a complex weight for each reception signal, on the basis of the same number of interference signals as the number of the receiving antennas 201.

The complex weight multiplication and combining unit 214 acquires the reception signals received by the receiving antennas 201-0 and 201-1 from the time-frequency timing detector 211, and acquires the calculated complex weights corresponding to the two reception signal lines from the complex weight calculator 213. The complex weight multiplication and combining unit 214 multiplies each reception signal by the corresponding complex weight (step S205). The complex weight multiplication and combining unit 214 combines the two-line reception signals that have been multiplied by the complex weights as shown in formula (1) (step S206) to obtain a reception signal with reduced interference. In formula (1), Wₙᵣ (r on the right side of n is a subscript of n) is a complex weight, and rₙᵣ (r on the right side of n is a subscript of n) is a reception signal. That is, the complex weight multiplication and combining unit 214 multiplies each of the plurality of reception signals by the corresponding complex weight, and combines the reception signals that have been multiplied by the complex weights.

Formula 1:

\tilde{r}(tₛ)=Σ_{n,}_{ᵣ}₌₀^{N}^{ᵣ}₋₁Wₙ_{ᵣ}rₙ_{ᵣ} (1)

The FSK demodulator 215 performs FSK demodulation on the reception signal having interference reduced by the complex weight multiplication and combining unit 214 (step S207). The likelihood calculator 216 calculates the likelihood of the reception signal FSK-demodulated by the FSK demodulator 215 (step S208). The deinterleaver 217 changes the order of bits of a likelihood sequence obtained by the likelihood calculator 216 (step S209). Specifically, the deinterleaver 217 brings the order of the bits changed by the interleaver 113 of the transmitting apparatus 100, back to the original order of the bits. The error-correction decoder 218 performs error correction on the likelihood sequence having the order of the bits changed by the deinterleaver 217 (step S210). The error-correction decoder 218 outputs a reception bit sequence that is the sequence having undergone the error correction. The control unit 270 controls the operation of the demodulator 210, that is, the operation of each unit included in the demodulator 210.

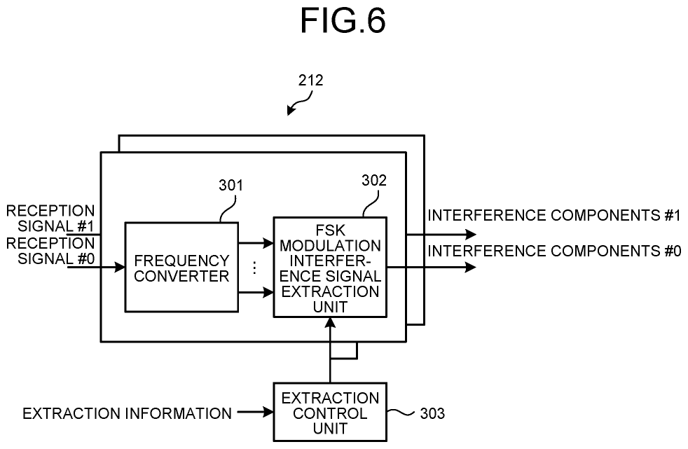

Interference extraction processing in the FSK modulation-compatible interference extraction unit 212 included in the demodulator 210 of the receiving apparatus 200 will be described in detail. FIG. 6 is a block diagram illustrating an example configuration of the FSK modulation-compatible interference extraction unit 212 included in the demodulator 210 of the receiving apparatus 200 according to the first embodiment. The FSK modulation-compatible interference extraction unit 212 includes a plurality of frequency converters 301, a plurality of FSK modulation interference signal extraction units 302, and an extraction control unit 303. The FSK modulation-compatible interference extraction unit 212 includes the same numbers of the frequency converters 301 and the FSK modulation interference signal extraction units 302 as the number of reception signals, that is, the number of the receiving antennas 201. Each frequency converter 301 applies phase rotation to a reception signal as shown in formula (2) to extract reception signal components of candidate frequencies at which power is concentrated.

Formula 2:

R₀(tₛ)=Σₜ₌₀^{T-1}r(tₛ+t)exp(j2πfₙt) (2)

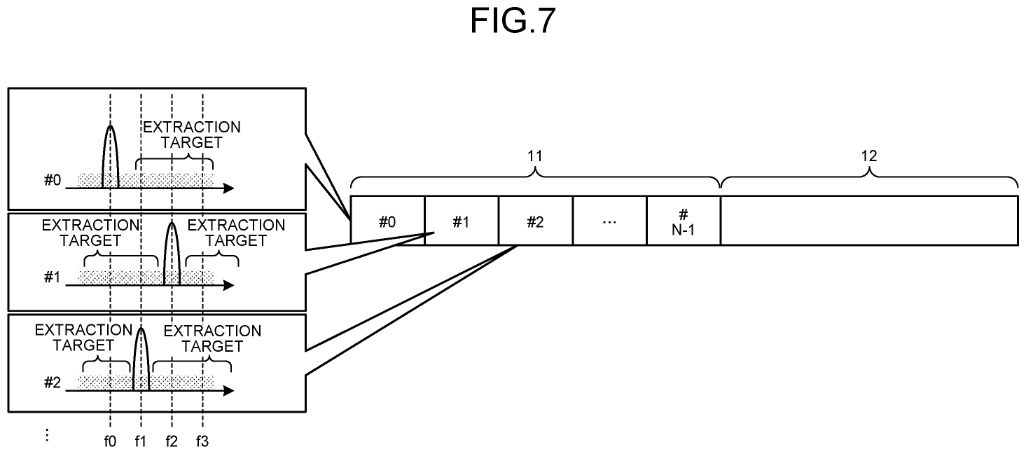

Each FSK modulation interference signal extraction unit 302 extracts, from the reception signal components of the candidate frequencies, an interference signal that is reception signal components corresponding to frequencies except reception signal components of frequencies at which a desired signal is present. As described above, this utilizes the characteristics of FSK modulation that allows a desired signal to be concentrated in power at specific frequencies. By utilizing the known sequence 11, the FSK modulation interference signal extraction units 302 can reliably extract reception signal components except desired signals. FIG. 7 is a diagram illustrating an image of an operation to extract interference signals in the FSK modulation interference signal extraction units 302 of the receiving apparatus 200 according to the first embodiment. As an example of FSK modulation, 4-level FSK will be described. As illustrated in FIG. 7, in a section of the known sequence 11, it is known at which frequencies of candidate frequencies the power of a desired signal modulated by 4-level FSK is concentrated. Specifically, in FIG. 7, for FSK symbol #0, power is concentrated at a frequency f0, for FSK symbol #1, power is concentrated at a frequency f2, and for FSK symbol #2, power is concentrated at a frequency f1. For FSK symbol #3 to FSK symbol #N−1 in the known sequence 11, power is also concentrated at any of the frequencies f0 to f3. In the following description, FSK symbols are sometimes simply referred to as symbols.

The extraction control unit 303 holds a frequency pattern that is information on FSK symbol numbers and frequencies at which power is concentrated in the known sequence 11. The frequency pattern held by the extraction control unit 303 may be acquired from the transmitting apparatus 100, or may be set in the extraction control unit 303 by a business operator operating the transmitting apparatus 100 and the receiving apparatus 200. On the basis of the held frequency pattern, the extraction control unit 303 indicates, to each FSK modulation interference signal extraction unit 302, a specified target interference signal to be extracted in each FSK symbol. This allows each FSK modulation interference signal extraction unit 302 to extract an interference signal from the reception signal components of the candidate frequencies. That is, the FSK modulation-compatible interference extraction unit 212 extracts the interference signals, on the basis of the frequency pattern of the desired signals of the known sequence 11 included in the reception signals.

By the way, not only the nearest transmitting apparatus 100 but also a remote transmitting apparatus 100 may transmit signals of the same data sequence 12, such that the signals of the same data sequence 12 are multiplexed and received with delay by the receiving apparatus 200. In such a case, a reception signal expression at the receiving apparatus 200 is equivalent to an expression of multipath reception. In the receiving apparatus 200, the power of a frequency corresponding to a desired signal of a signal one symbol past is observed in the frequency domain of a delayed wave in accordance with the delay amount. A range in which the receiving apparatus 200 extracts an interference signal as measures against a delayed wave is different from that as measures against an interfering wave. For this reason, the receiving apparatus 200 controls the extraction of interference signals according to targets against which to take measures.

Specifically, measures against a delayed wave will be described. Assume that there is one delayed wave, and the delay length of the delayed wave is a delay within one symbol. In this case, the receiving apparatus 200 observes, in a preamble section that is the section of the known sequence 11, the desired signal frequency of the FSK symbol and also the frequency of an FSK symbol one symbol past. The receiving apparatus 200 knows a frequency transition rule that defines at which frequency the power is concentrated for each FSK symbol in the preamble section. Thus, the receiving apparatus 200 knows at which frequencies the signal components of the delayed wave are observed. Taking into consideration frequencies at which power is concentrated, thus, the receiving apparatus 200 extracts interference signals to thereby efficiently extract frequency components corresponding to delayed waves. For example, in order to enable the receiving apparatus 200 to extract interference signals, the known sequence generation unit 114 of the transmitting apparatus 100 may generate the known sequence 11 in which temporally adjacent symbols after modulation by FSK do not coincide in frequency at which power is concentrated. Furthermore, even if there is a plurality of delayed waves, a delay of one symbol or more, or the like, the receiving apparatus 200 can determine at which frequencies the power is concentrated in the preamble section, and thus can extract interference signals, taking into consideration the frequencies at which power is concentrated. For interference signal extraction processing, the receiving apparatus 200 may perform multipath estimation in the preamble section to determine propagation path states, and then perform the interference signal extraction processing.

On the other hand, for measures against an interfering wave, the receiving apparatus 200 cannot know the characteristics, properties, etc. of the interfering wave, and therefore extracts interference signals that are frequency components except the frequencies of desired signals.

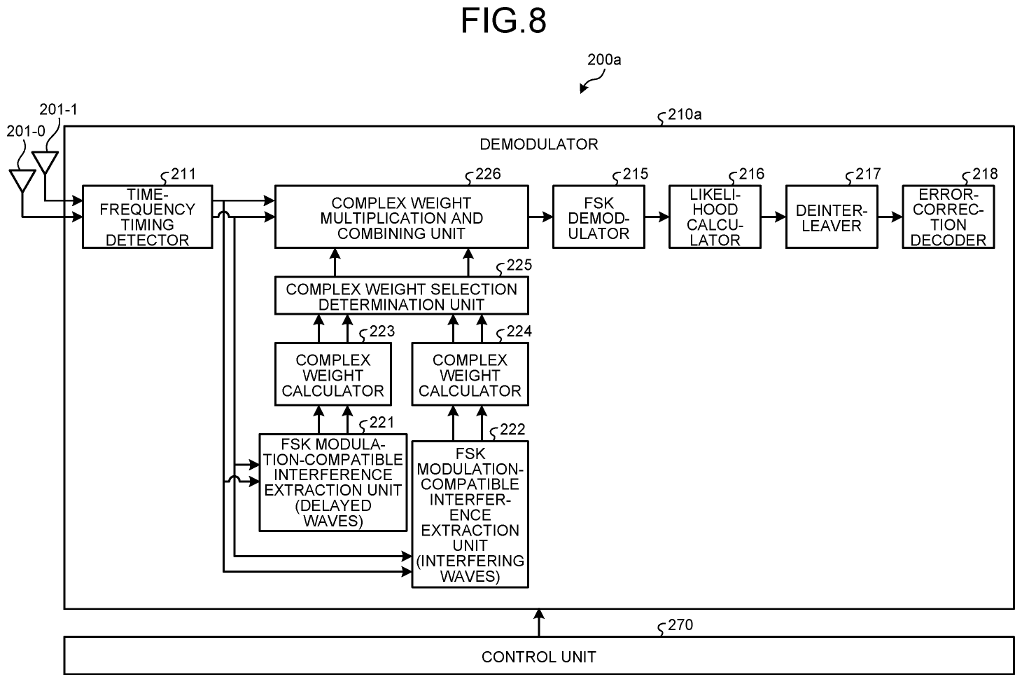

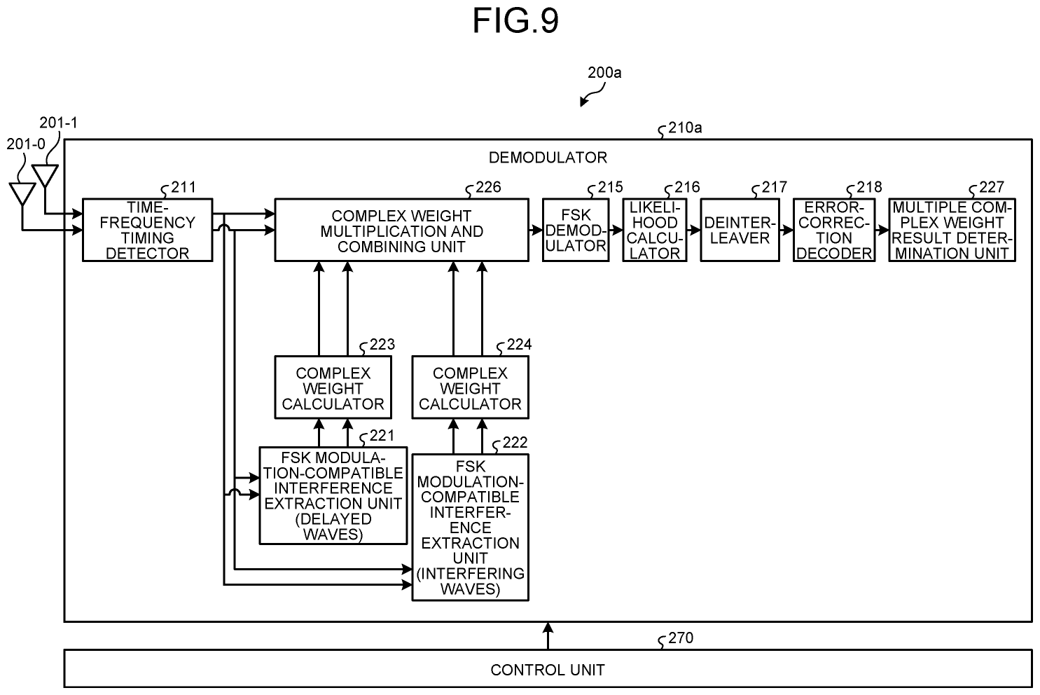

FIG. 8 is a first block diagram illustrating an example configuration of a receiving apparatus 200a that extracts interference signals with delayed waves taken into consideration in the first embodiment. The receiving apparatus 200a includes the receiving antennas 201-0 and 201-1, a demodulator 210a, and the control unit 270. The demodulator 210a is different from the demodulator 210 illustrated in FIG. 4 in that the FSK modulation-compatible interference extraction unit 212, the complex weight calculator 213, and the complex weight multiplication and combining unit 214 are removed, and FSK modulation-compatible interference extraction units 221 and 222, complex weight calculators 223 and 224, a complex weight selection determination unit 225, and a complex weight multiplication and combining unit 226 are added. For example, the FSK modulation-compatible interference extraction unit 221 and the complex weight calculator 223 are provided for delayed waves, and the FSK modulation-compatible interference extraction unit 222 and the complex weight calculator 224 are provided for interfering waves. The complex weight selection determination unit 225 selects, from the complex weight calculator 223 or the complex weight calculator 224, complex weights that more contribute to communication performance improvements, on the basis of measured values of desired signal power, delayed wave power, interfering wave power, etc., and outputs the selected complex weights to the complex weight multiplication and combining unit 226. The complex weight multiplication and combining unit 226 performs the same operation as the complex weight multiplication and combining unit 214 described above, using the complex weights selected by the complex weight selection determination unit 225. Complex weight selection determination may result in a mistaken determination when an error in the measurement of an index value that should be a selection criterion is large. FIG. 9 is a second block diagram illustrating an example configuration of the receiving apparatus 200a that extracts interference signals, taking delayed waves into consideration in the first embodiment. As illustrated in FIG. 9, after demodulation and decoding using the individual complex weights are performed, a multiple complex weight result determination unit 227 of the receiving apparatus 200a may select a more probable one on the basis of multiple results obtained by the results of cyclic redundancy checks (CRCs), likelihood values, etc. In the example of FIG. 9, the multiple complex weight result determination unit 227 is disposed behind and connected to the error-correction decoder 218, which is not exhaustive.

The receiving apparatus 200a may include multiple, that is, three or more FSK modulation-compatible interference extraction units and three or more complex weight calculators. The multiple interference extraction units extract interference signals that are frequency components in different ranges. In the example of FIG. 8, at least one interference extraction unit of the multiple interference extraction units extracts interference signals that are frequency components corresponding to delayed waves, on the basis of the frequency pattern. The multiple complex weight calculators are individually connected to the different interference extraction units, and calculate complex weights on the basis of interference signals extracted by the connected interference extraction units. The complex weight selection determination unit 225 selects a complex weight corresponding to each reception signal, from multiple complex weights calculated by the multiple complex weight calculators, and outputs the selected complex weights to the complex weight multiplication and combining unit 226.

Next, a hardware configuration of the transmitting apparatus 100 will be described. In the transmitting apparatus 100, the transmitting antenna 117 is an antenna element. The modulator 110 and the control unit 130 are implemented by processing circuitry. The processing circuitry may be a processor to execute a program stored in memory and the memory, or may be dedicated hardware. The processing circuitry is also referred to as a control circuit.

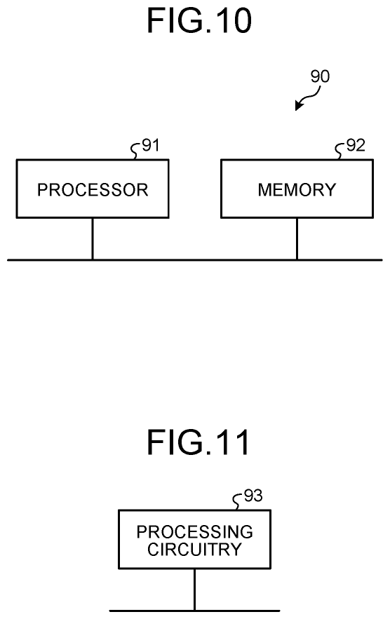

FIG. 10 is a diagram illustrating an example configuration of processing circuitry 90 when a processor 91 and memory 92 implement processing circuitry included in the transmitting apparatus 100 according to the first embodiment. The processing circuitry 90 illustrated in FIG. 10 is a control circuit and includes the processor 91 and the memory 92. When the processor 91 and the memory 92 constitute the processing circuitry 90, functions of the processing circuitry 90 are implemented by software, firmware, or a combination of software and firmware. The software or firmware is described as a program and stored in the memory 92. In the processing circuitry 90, the processor 91 reads and executes the program stored in the memory 92, thereby implementing each function. That is, the processing circuitry 90 includes the memory 92 for storing the program that results in the execution of the processing in the transmitting apparatus 100. This program can be said to be a program for causing the transmitting apparatus 100 to perform the functions implemented by the processing circuitry 90. This program may be provided via a storage medium on which the program is stored, or may be provided via another means such as a communication medium.

The program can be said to be a program to cause the transmitting apparatus 100 to perform a first step of generating, by the known sequence generation unit 114, a known sequence to be multiplexed with a data sequence, a second step of multiplexing, by the multiplexer 115, the data sequence and the known sequence, and a third step of modulating, by the FSK modulator 116, a signal into which the data sequence and the known sequence are multiplexed, by a frequency modulation scheme, in which in the first step, the known sequence generation unit 114 generates the known sequence in which, after modulation by the frequency modulation scheme, temporally adjacent symbols do not coincide in frequency at which power is concentrated.

Here, the processor 91 is, for example, a central processing unit (CPU), a processing unit, an arithmetic device, a microprocessor, a microcomputer, a digital signal processor (DSP), or the like. The memory 92 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disc (DVD), or the like.

FIG. 11 is a diagram illustrating an example of processing circuitry 93 when dedicated hardware constitutes the processing circuitry included in the transmitting apparatus 100 according to the first embodiment. The processing circuitry 93 illustrated in FIG. 11 corresponds, for example, to a single circuit, a combined circuit, a programmed processor, a parallel-programmed processor, an application-specific integrated circuit (ASIC), a field-programmable gate array (FPGA), or a combination of them. The processing circuitry may be implemented partly by dedicated hardware and partly by software or firmware. Thus, the processing circuitry can implement the above-described functions by dedicated hardware, software, firmware, or a combination of them.

A hardware configuration of the receiving apparatus 200 is the same as the hardware configuration of the transmitting apparatus 100. In the receiving apparatus 200, the receiving antennas 201 are antenna elements. The demodulator 210 and the control unit 270 are implemented by processing circuitry. The processing circuitry may be a processor to execute a program stored in memory and the memory, or may be dedicated hardware. A hardware configuration of the receiving apparatus 200a is also the same as the hardware configuration of the transmitting apparatus 100.

As described above, according to the present embodiment, the transmitting apparatus 100 performs FSK modulation on a signal obtained by multiplexing the data sequence 12 and the known sequence 11 and transmit that FSK-modulated signal. Focusing on the characteristics of FSK modulation that allows the concentration of power at specific frequencies, the receiving apparatus 200 extracts, from reception signals, interference signals that are frequency components other than the frequency components of desired signals. Consequently, the receiving apparatus 200 can efficiently and highly accurately extract interference signals. Furthermore, the receiving apparatus 200 has movement resistance, and can prevent a decrease in accuracy in extracting interference signals included in reception signals.

### Second Embodiment

A second embodiment describes a method for a receiving apparatus to efficiently extract interference signals when a transmitting apparatus performing STBC coding, that is, space-time block coding on FSK-modulated signals transmits the STBC-coded signals.

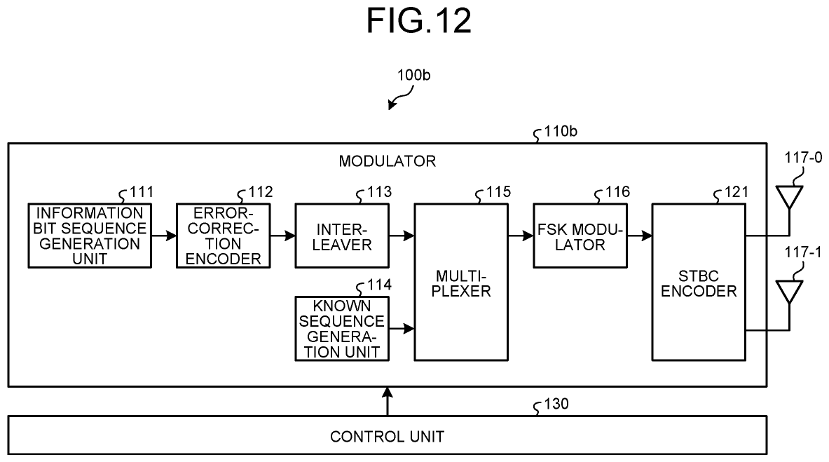

FIG. 12 is a block diagram illustrating an example configuration of a transmitting apparatus 100b according to the second embodiment. The transmitting apparatus 100b includes a modulator 110b, transmitting antennas 117-0 and 117-1, and the control unit 130. The modulator 110b is different to from the modulator 110 illustrated in FIG. 2 in that an STBC encoder 121 is added. In the transmitting apparatus 100b, operation up to the FSK modulator 116 is the same as the operation of the transmitting apparatus 100 of the first embodiment.

The STBC encoder 121 performs STBC coding on a signal that has undergone FSK modulation at the FSK modulator 116, on the basis of an STBC code rule in formula (3) below. The STBC encoder 121 transmits the STBC-coded signal from the transmitting antennas 117-0 and 117-1 using the same frequency. In formula (3), d₀, ₀(tₛ) is FSK symbol #0 in STBC block #0. tₛ corresponds to a sample number in FSK symbols. In the following description, an STBC block is sometimes simply referred to as a block.

$$\begin{matrix}Formula 3 : & \\ [ \begin{matrix}{d}_{0 , 0} ( {t}_{s} ) & - {d}_{1 , 0}^{*} ( {t}_{s} ) \\ {d}_{1 , 0} ( {t}_{s} ) & {d}_{0 , 0}^{*} ( {t}_{s} )\end{matrix} ] & ( 3 )\end{matrix}$$

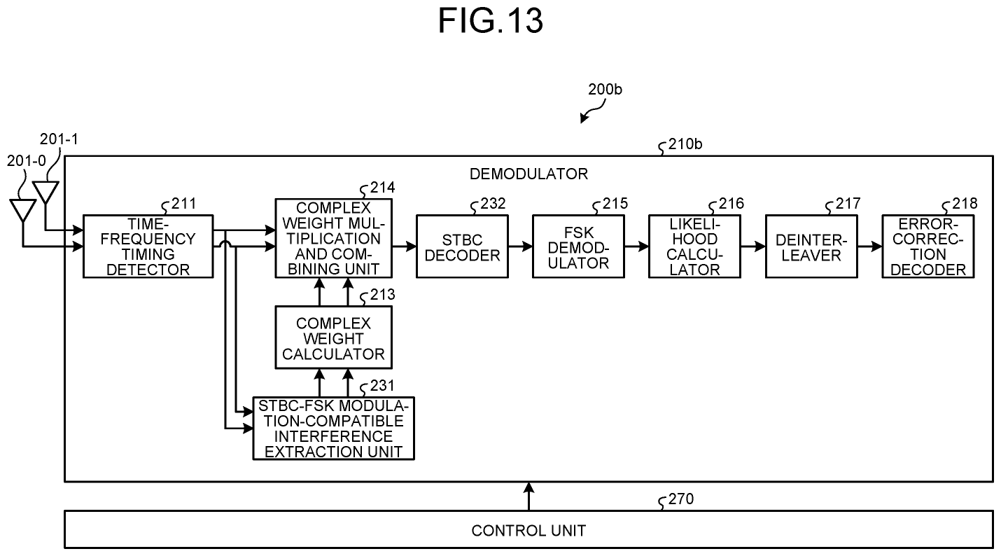

FIG. 13 is a block diagram illustrating an example configuration of a receiving apparatus 200b according to the second embodiment. The receiving apparatus 200b includes the receiving antennas 201-0 and 201-1, a demodulator 210b, and the control unit 270. The demodulator 210b is different from the demodulator 210 illustrated in FIG. 4 in that the FSK modulation-compatible interference extraction unit 212 is removed and an STBC-FSK modulation-compatible interference extraction unit 231 and an STBC decoder 232 are added.

For adaptive array processing, the STBC-FSK modulation-compatible interference extraction unit 231 is an interference extraction unit that performs frequency conversion on STBC-coded and FSK-modulated preamble sections of reception signals whose time and frequency timings have been detected by the time-frequency timing detector 211, and extracts interference signals, on the basis of the same rule as that of the FSK modulation interference signal extraction units 302 of the first embodiment, that is, on the basis of the frequency pattern. The operations of the complex weight calculator 213 and the complex weight multiplication and combining unit 214 are the same as those in the first embodiment. The STBC decoder 232 performs STBC decoding on a reception signal having interference reduced by the complex weight multiplication and combining unit 214. Operation in and after the FSK demodulator 215 is the same as that of the first embodiment.

When signals are transmitted from the transmitting apparatus 100b according to the STBC code rule shown in formula (3), in the receiving apparatus 200b, reception signals at the receiving antenna 201-0 are expressed as formulas (4) and (5) below.

Formula 4:

r₀(t_{b}=0,t=0,tₛ)=h_{0,0}d_{0,0}(tₛ)+h_{0,1}d_{1,0}(tₛ) (4)

Formula 5:

r₀(t_{b}=0,t=1,tₛ)=−h_{0,0}d_{1,0}*(tₛ)+h_{0,1}d_{1,0}(tₛ) (5)

In formulas (4) and (5), r₀(0, 0, tₛ) is a reception signal of t_{b}=0 at the receiving antenna 201-0, that is, t=0 of STBC block #0, that is, FSK symbol #0, and h_{0,0} is a channel coefficient between the transmitting antenna 117-0 and the receiving antenna 201-0.

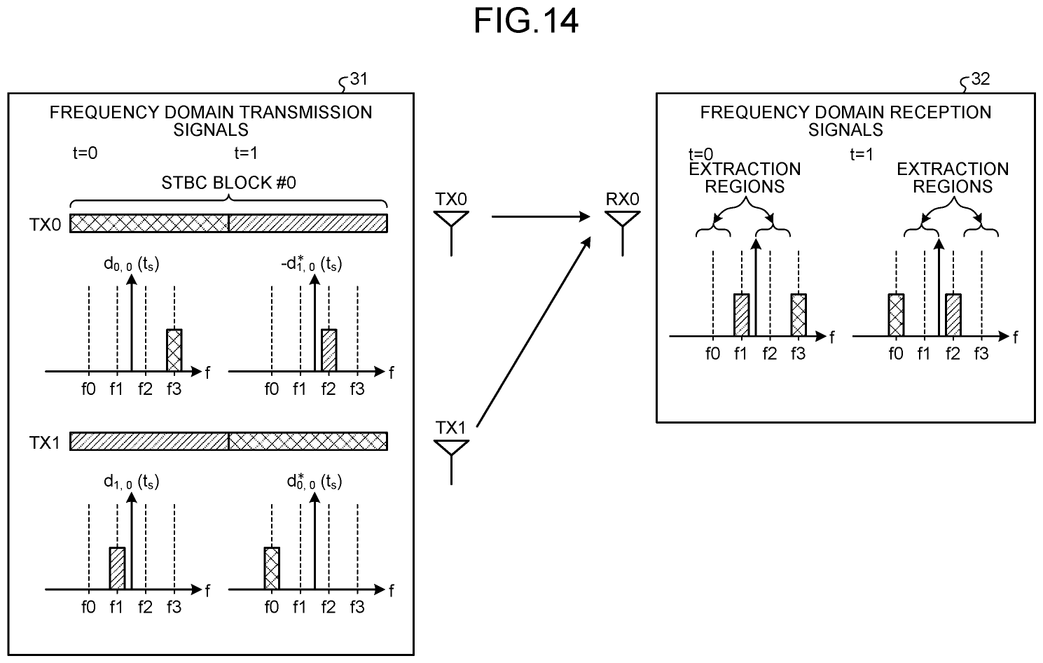

A description is given of signals transmitted from a transmitting apparatus and signals received by the receiving apparatus 200b as the transmitting apparatus performs STBC coding and FSK modulation without using the characteristic known sequence 11, unlike the transmitting apparatus 100b of the present embodiment. FIG. 14 is a diagram illustrating an example of signals transmitted from the transmitting apparatus performing STBC coding and FSK modulation without using the characteristic known sequence 11, and signals received by the receiving apparatus 200b in the second embodiment as a comparative example. When the transmitting apparatus does not take into consideration specific frequencies at which power is concentrated in the known sequence 11, frequency domain transmission signals 31 transmitted from the transmitting apparatus are expressed as on the left side of FIG. 14. In this case, frequency domain reception signals 32 received by the receiving apparatus 200b are expressed as on the right side of FIG. 14. When the receiving apparatus 200b performs frequency conversion on the frequency domain transmission signals 31 in extracting interference, a plurality of frequency components are observed as illustrated in FIG. 14. For example, in r₀(0, 0, tₛ), the frequency components of d₀, ₀(tₛ) and d₁, ₀(tₛ) are observed.

When the transmitting apparatus performs STBC coding and FSK modulation in the preamble section for extracting interference signals on the basis of a random bit sequence, as illustrated in the frequency domain reception signals 32 of FIG. 14, two frequency components are observed as desired signals, and interference signal extraction regions in the frequency domain are narrowed. Furthermore, as described above, to reduce interference from a delayed wave when the frequency components of desired signals are superimposed on frequencies at which delayed wave components are observed, the receiving apparatus 200b fails to efficiently extract interference signals in the limited preamble section.

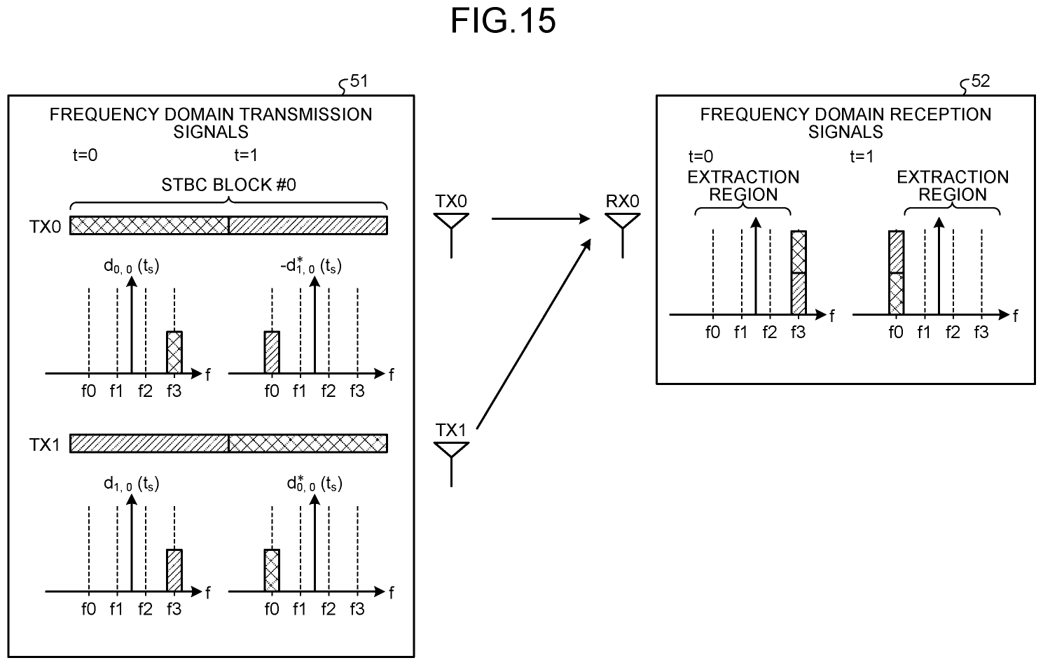

In view of this, the transmitting apparatus 100b of the present embodiment performs characteristic STBC coding and FSK modulation processing. FIG. 15 is a diagram illustrating an example of signals transmitted from the transmitting apparatus 100b and signals received by the receiving apparatus 200b according to the second embodiment. Frequency domain transmission signals 51 illustrated in FIG. 15 include the known sequence 11 that takes into consideration the STBC code rule in FSK modulation. When the transmitting apparatus 100b employs FSK modulation as illustrated in FIG. 15, a conjugate FSK symbol of a certain FSK symbol has a signal component generated at an opposite frequency opposite to and reflective of the frequency component of the certain FSK symbol about the center frequency. When the transmitting apparatus 100b uses a bit sequence satisfying the relationship d₀, ₀(tₛ)=d₁, ₀(tₛ) for the preamble section, the receiving apparatus 200b can efficiently extract interference signals because the power is concentrated at specific frequencies when the reception signals are superimposed on each other, as shown by frequency domain reception signals 52 in FIG. 15. In this case, the known sequence generation unit 114 of the transmitting apparatus 100b generates the known sequence 11 so that power is concentrated at specific frequencies when signals transmitted from the plurality of transmitting antennas 117-0 and 117-1 are superimposed together at the receiving apparatus 200b.

For the STBC code rule, formula (6) below is another example thereof.

$$\begin{matrix}Formula 6 : & \\ [ \begin{matrix}{d}_{0 , 0} ( {t}_{s} ) & {d}_{1 , 0} ( {t}_{s} ) \\ - {d}_{1 , 0}^{*} ( {t}_{s} ) & {d}_{0 , 0}^{*} ( {t}_{s} )\end{matrix} ] & ( 6 )\end{matrix}$$

For formula (6), the known sequence 11 satisfying a relationship in formula (7) below can be used, and only needs to satisfy a rule of concentration at one frequency.

Formula 7:

d_{0,0}(tₛ)=d_{1,0}*(tₛ) (7)

A hardware configuration of the transmitting apparatus 100b is the same as the hardware configuration of the transmitting apparatus 100 of the first embodiment. A hardware configuration of the receiving apparatus 200b is the same as the hardware configuration of the receiving apparatus 200 of the first embodiment.

As described above, according to the present embodiment, the transmitting apparatus 100b generates the known sequence 11 so that power is concentrated at specific frequencies when signals transmitted from the transmitting antennas 117-0 and 117-1 are superimposed together at the receiving apparatus 200b. Consequently, when reception signals are superimposed together, power is concentrated at specific frequencies, so that the receiving apparatus 200b can efficiently extract interference signals.

### Third Embodiment

The second embodiment has described the known sequence 11 for achieving efficient interference signal extraction within an STBC-coded block. A third embodiment describes the known sequence 11 provided for interference signal extraction of delayed waves outside an STBC-coded block, i.e., between STBC blocks.

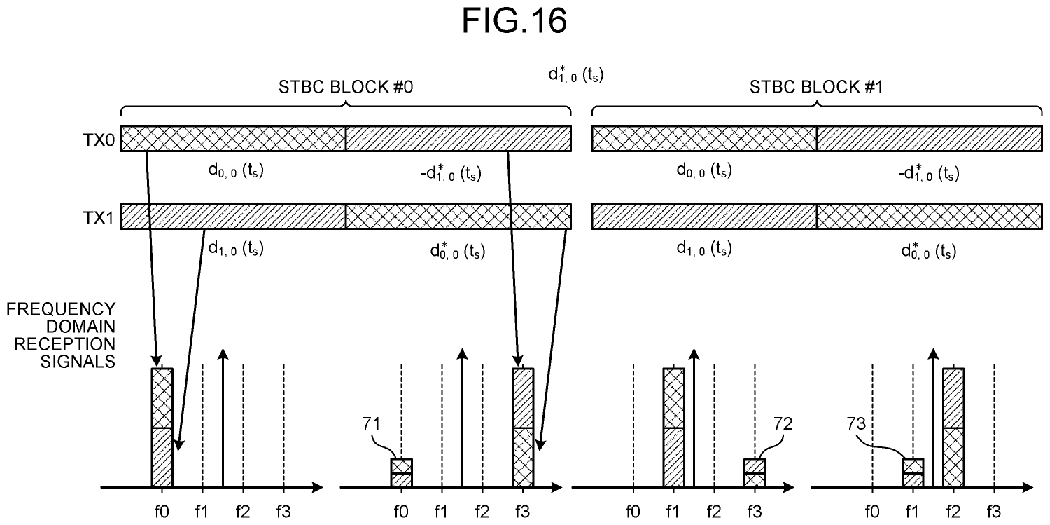

In the present embodiment, the configurations of the transmitting apparatus 100b and the receiving apparatus 200b are the same as the configurations of the transmitting apparatus 100b and the receiving apparatus 200b of the second embodiment. As is the case with the second embodiment, when random frequencies are assigned in adjacent STBC-coded blocks in the known sequence 11, interference signals cannot be extracted if the frequency components of delayed waves are superimposed on the frequency components of desired signals. In the present embodiment, therefore, STBC-coded and FSK-modulated symbols are determined as the known sequence 11 such that the frequency components of delayed waves are not superimposed on the frequency components of desired signals between adjacent STBC-coded blocks. FIG. 16 is a diagram illustrating an example of the known sequence 11 intended to superimpose desired signals on the same frequencies in an STBC block so as to avoid superimposition of delayed waves on the desired signals outside the STBC block in the third embodiment. In STBC block #0, the frequency f3 of FSK symbol #1 within STBC block #0 is observed as delayed wave components 72 at the frequency f3 in FSK symbol #0 within STBC block #1. In FIG. 16, the frequency of the desired signals of FSK symbol #0 within STBC block #1 is set to f1 so as not to coincide with the frequency components of the delayed waves.

According to the above idea, the known sequence 11 at the time of one-antenna transmission may also be a sequence in which adjacent FSK symbols do not have the same desired signal frequency. In another transmit diversity, the known sequence 11 may be designed to prevent the frequencies of desired signals from being the same between antennas or between adjacent symbols. In the example of FIG. 16, delayed wave components 71 at the frequency f0 of FSK symbol #0 within STBC block #0 are observed in FSK symbol #1 within the STBC block #0 without coinciding with the frequency f3 of the desired signals. Likewise, delayed wave components 73 at the frequency f1 of FSK symbol #0 within STBC block #1 are observed in FSK symbol #1 within the STBC block #1 without coinciding with the frequency f2 of the desired signals. In this case, the known sequence generation unit 114 of the transmitting apparatus 100b generates the known sequence 11 in which temporally adjacent FSK symbols or STBC blocks after STBC coding do not coincide in frequency at which power is concentrated.

As described above, according to the present embodiment, the transmitting apparatus 100b generates the known sequence 11 in which temporally adjacent FSK symbols or STBC blocks after STBC coding do not coincide in frequency at which power is concentrated. This allows the receiving apparatus 200b to efficiently extract interference signals because power is concentrated at specific frequencies when reception signals are superimposed together, and delayed wave components do not coincide with the frequencies of desired signals.

### Fourth Embodiment

In the second embodiment, the STBC-FSK modulation-compatible interference extraction unit 231 of the receiving apparatus 200b performs frequency conversion in accordance with FSK symbol timings and extracts specified frequency components as interference signals. In the second embodiment, the efficient interference signal extraction method, which takes into consideration the characteristics of STBC-coding and FSK modulation prevents the narrowing of the ranges in which to extract interference signals resulting from multi-antenna transmission in the known sequence 11. In this case, time and frequency synchronization performance using the known sequence 11 is limited by the above design. In view of this, a fourth embodiment describes a method that allows a receiving apparatus to perform inverse modulation on STBC-coded and FSK-modulated signals to extract desired signals in the form of DC components, thereby preventing the narrowing of the ranges in which to extract interference signals in the frequency domain. This eliminates the need for restrictions as described in the second embodiment in the known sequence 11.

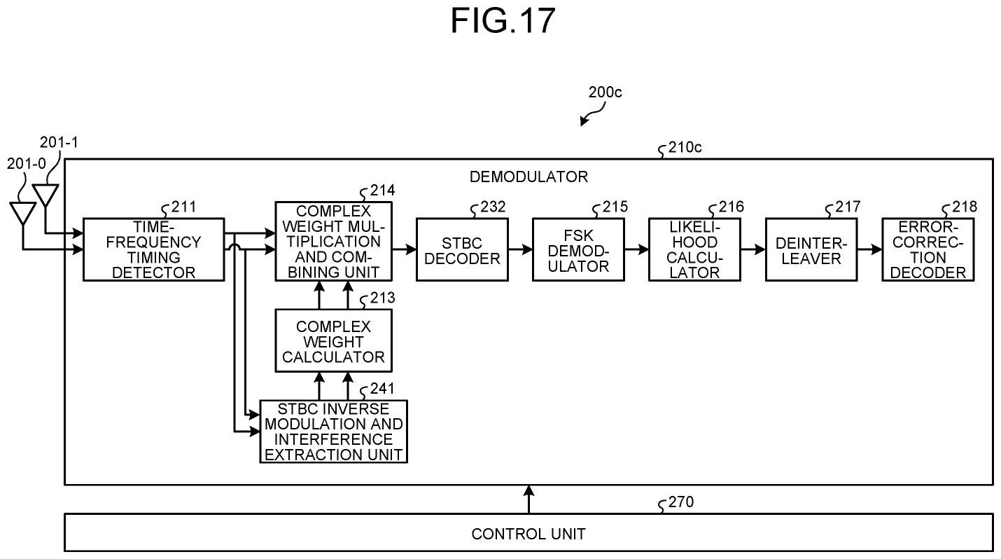

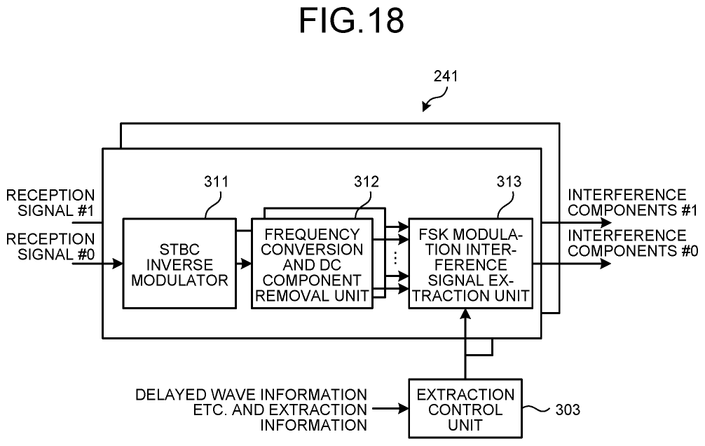

FIG. 17 is a block diagram illustrating an example configuration of a receiving apparatus 200c according to the fourth embodiment. The receiving apparatus 200c includes the receiving antennas 201-0 and 201-1, a demodulator 210c, and the control unit 270. The demodulator 210c is different from the demodulator 210b illustrated in FIG. 13 in that the STBC-FSK modulation-compatible interference extraction unit 231 is removed and an STBC inverse modulation and interference extraction unit 241 is added. FIG. 18 is a block diagram illustrating an example configuration of the STBC inverse modulation and interference extraction unit 241 included in the demodulator 210c of the receiving apparatus 200c according to the fourth embodiment. The STBC inverse modulation and interference extraction unit 241 includes a plurality of STBC inverse modulators 311, a plurality of frequency conversion and DC component removal units 312, a plurality of FSK modulation interference signal extraction units 313, and the extraction control unit 303. The STBC inverse modulators 311 perform STBC-coding inverse modulation processing on reception signals from the receiving antennas 201. Formulas (8) and (9) below represent the STBC-coding inverse modulation processing on reception signals of the receiving antenna 201-0. From these formulas, channel estimate values between the transmitting antennas 117-0 and 117-1 of the transmitting apparatus 100b and the receiving antenna 201-0 are obtained.

Formula 8:

ĥ_{0,0}={d_{0,0}*(tₛ)r₀(0,0,tₛ)−d_{1,0}(tₛ)r₀(0,1,tₛ)}/2 (8)

Formula 9:

ĥ_{0,1}={d_{1,0}*(tₛ)+d_{0,0}(tₛ)r₀(0,1tₛ)}/2 (9)

The STBC inverse modulators 311 outputs the obtained channel estimate values to the frequency conversion and DC component removal units 312. The channel estimate values represented by formulas (8) and (9) correspond to DC components. Thus, like the frequency converters 301, the frequency conversion and DC component removal units 312 apply phase rotation to the channel estimate values for frequency conversion, and remove the DC components after the frequency conversion. The frequency conversion and DC component removal units 312 output, to the FSK modulation interference signal extraction units 313, the frequency components having the DC components removed. On the basis of the held frequency pattern, the extraction control unit 303 indicates, to each FSK modulation interference signal extraction unit 313, specified target interference signals to be extracted. The FSK modulation interference signal extraction units 313 extract interference signals that are frequency components specified from the extraction control unit 303. As described above, the STBC inverse modulation and interference extraction unit 241 is an interference extraction unit that performs STBC-coding inverse modulation processing on the sections of the known sequence 11 of the STBC-coded and FSK-modulated reception signals, frequency-converts channel estimate values obtained and then removes DC components, and extracts interference signals on the basis of the frequency pattern.

In the second embodiment, the receiving apparatus 200b performs direct frequency conversion on reception signals to observe a plurality of frequency components resulting from multiplexing of FSK symbols of different frequencies from the different transmitting antennas 117-0 and 117-1, so that interference signal extraction regions are narrowed disadvantageously. In contrast, according to the present embodiment, the receiving apparatus 200c can extract a single frequency component for a desired signal at the time of frequency conversion by applying STBC inverse modulation, and can avoid the narrowing of interference signal extraction regions.

As in the first embodiment, the receiving apparatus 200c can efficiently extract frequency components of delayed waves by estimating the amounts of leakage of FSK symbols that arrive with delay, on the basis of the known sequence 11, and using the estimated leakage amounts as delayed wave information.

A hardware configuration of the receiving apparatus 200c is the same as the hardware configuration of the receiving apparatus 200 of the first embodiment.

### Fifth Embodiment

In the first to fourth embodiments, the receiving apparatus calculates complex weights in the known sequence 11, and performs multiplication using the determined complex weights and combining processing on data sections that are the sections of the data sequence 12. This means that appropriate complex weights are not used when the angles of arrival or the like of delayed waves, interfering waves, etc. change within one frame, which results in degradation of demodulation performance. In view of this, the present embodiment describes a method that allows a receiving apparatus to calculate appropriate complex weights even when conditions of delayed waves, interfering waves, etc. change within one frame. Specifically, the receiving apparatus performs interference signal extraction processing also on data sections, and calculates complex weights appropriate to conditions of delayed waves, interfering waves, etc. in the data sections.

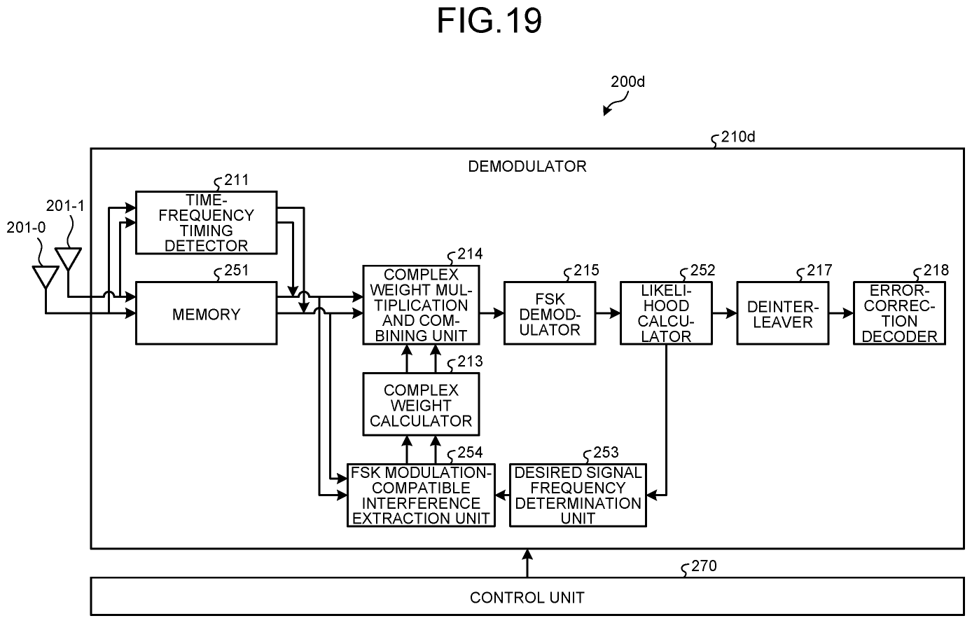

FIG. 19 is a first block diagram illustrating an example configuration of a receiving apparatus 200d according to a fifth embodiment. The receiving apparatus 200d includes the receiving antennas 201-0 and 201-1, a demodulator 210d, and the control unit 270. The demodulator 210d is different from the demodulator 210 in FIG. 4 in that the FSK modulation-compatible interference extraction unit 212 and the likelihood calculator 216 are removed, and memory 251, a likelihood calculator 252, a desired signal frequency determination unit 253, and an FSK modulation-compatible interference extraction unit 254 are added. The FSK modulation-compatible interference extraction unit 254 uses likelihood information, i.e., a likelihood sequence once obtained by processing of the FSK demodulator 215 and the likelihood calculator 252 on a data section.

Specifically, the likelihood calculator 252 performs the same calculation as the likelihood calculator 216 of the first embodiment, but outputs a calculated likelihood sequence, that is, likelihood information to the desired signal frequency determination unit 253 as well as to the deinterleaver 217. On the basis of the likelihood information acquired from the likelihood calculator 252, the desired signal frequency determination unit 253 determines frequencies that are presumed to be a desired signal. The desired signal frequency determination unit 253 outputs information on the determined desired signal frequencies to the FSK modulation-compatible interference extraction unit 254. The FSK modulation-compatible interference extraction unit 254 has the same configuration as the FSK modulation-compatible interference extraction unit 212. In the FSK modulation-compatible interference extraction unit 254, on the basis of the desired signal frequency information acquired from the desired signal frequency determination unit 253, the extraction control unit 303 indicates, to each FSK modulation interference signal extraction unit 302, a specified target interference signal to be extracted in each FSK symbol. On the basis of the interference signals obtained by the FSK modulation-compatible interference extraction unit 254, the complex weight calculator 213 calculates complex weights corresponding to the two reception signal lines. In the receiving apparatus 200d, interference signal extraction and complex weight calculation are performed again, on the basis of the likelihood information output from the likelihood calculator 252. When multiplying reception signals by the complex weights, the complex weight multiplication and combining unit 214 reads the corresponding reception signals from the memory 251. Since the complex weights appropriate to target data sections are calculated by the complex weight calculator 213, the complex weight multiplication and combining unit 214 can reduce delayed waves, interfering waves, etc. more appropriately.

In the above example, a likelihood sequence is used to determine desired signal frequencies, which is not limiting. For example, comparisons of the power values of individual frequencies with a threshold may be performed to determine desired signal frequencies.

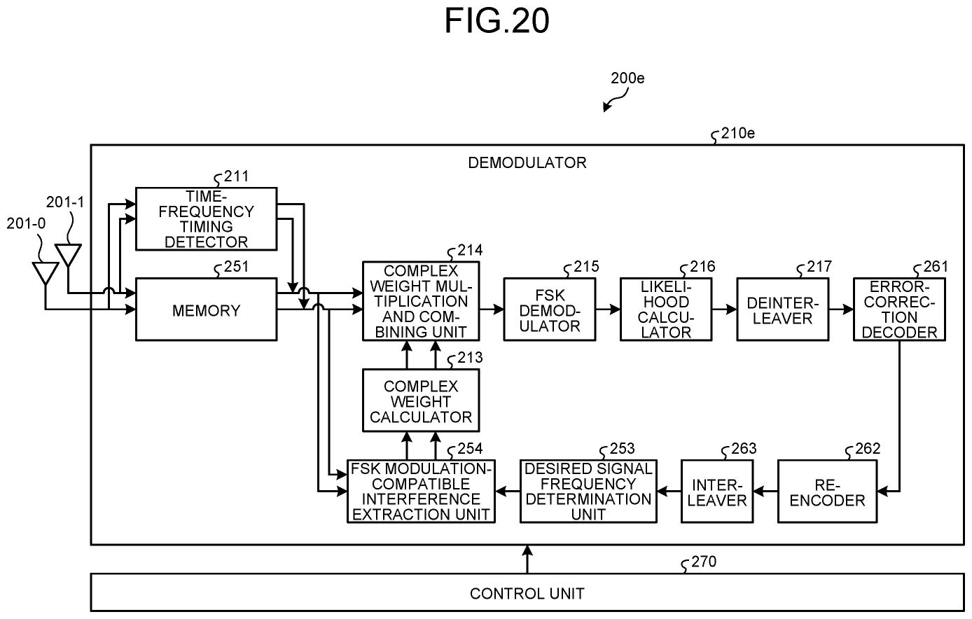

FIG. 20 is a second block diagram illustrating an example configuration of a receiving apparatus 200e according to the fifth embodiment. The receiving apparatus 200e includes the receiving antennas 201-0 and 201-1, a demodulator 210e, and the control unit 270. The demodulator 210e is different from the demodulator 210 in FIG. 4 in that the FSK modulation-compatible interference extraction unit 212 and the error-correction decoder 218 are removed and the memory 251, the desired signal frequency determination unit 253, the FSK modulation-compatible interference extraction unit 254, an error-correction decoder 261, a re-encoder 262, and an interleaver 263 are added. The FSK modulation-compatible interference extraction unit 254 uses information on a reception bit sequence that is an error-corrected sequence once obtained by processing of the FSK demodulator 215, the likelihood calculator 216, the deinterleaver 217, and the error-correction decoder 261 on a data section.

Specifically, the error-correction decoder 261 outputs, to the re-encoder 262, a reception bit sequence that is an obtained error-corrected sequence. The re-encoder 262 performs re-encoding, that is, the same error-correction coding processing as the error-correction encoder 112 of the transmitting apparatus 100 on the reception bit sequence that is the error-corrected sequence. Like the interleaver 113 of the transmitting apparatus 100, for the encoded bit sequence acquired from the re-encoder 262, the interleaver 263 changes the order of bits defining the encoded bit sequence, and outputs, to the desired signal frequency determination unit 253, the bit sequence having the order changed. Subsequent operation is the same as that of the receiving apparatus 200d illustrated in FIG. 19. When the error-correction decoder 261 of the receiving apparatus 200e can obtain a reception bit sequence and a parity bit likelihood sequence at the same time, re-encoding is unnecessary, and the frequencies may be determined from the likelihood of bits constituting FSK-modulated symbols at the time of transmission.

As described above, in the receiving apparatus 200d or the receiving apparatus 200e, the desired signal frequency determination unit 253 determines desired signal frequencies in the section of the data sequence 12 of a signal obtained from a signal obtained by demodulating an FSK-modulated signal or a signal obtained by decoding error correction. The FSK modulation-compatible interference extraction unit 254 is an interference extraction unit that extracts interference signals from the sections of the data sequence 12, on the basis of the desired signal frequencies in the section of the data sequence 12 determined by the desired signal frequency determination unit 253. The complex weight calculator 213 calculates complex weights on the basis of the interference signals in the sections of the data sequence 12 extracted by the FSK modulation-compatible interference extraction unit 254. The complex weight multiplication and combining unit 214 multiplies the sections of the data sequence 12 of the plurality of reception signals by the corresponding complex weights, and combines the reception signals that have been multiplied by the complex weights.

The present embodiment is not limited to the above examples, and various combinations are possible. For example, the present embodiment is also applicable to the receiving apparatus 200a illustrated in FIGS. 8 and 9. The receiving apparatus may estimate the presence of delayed waves in FSK symbols in preamble sections, and using the results, perform interference signal extraction only on delayed wave components in data sections.

Hardware configurations of the receiving apparatuses 200d and 200e are the same as the hardware configuration of the receiving apparatus 200 of the first embodiment.

As described above, according to the present embodiment, the receiving apparatus 200d and the receiving apparatus 200e also perform, on sections of the data sequence 12, the processing of extracting interference signals, calculating complex weights, and multiplying reception signals by the complex weights and combining the reception signals. Consequently, even when the angles of arrival or the like of delayed waves, interfering waves, etc. change within one frame, the receiving apparatus 200d and the receiving apparatus 200e can accurately extract interference signals and calculate appropriate complex weights, thereby preventing degradation of demodulation performance in the data sequence 12.

The receiving apparatus according to the present disclosure has the effect of preventing the decrease in accuracy in extracting the interference signals included in the reception signals in the wireless communication using the frequency modulation scheme.

The configurations described in the above embodiments illustrate an example and can be combined with another known art. The embodiments can be combined with each other. The configurations can be partly omitted or changed without departing from the gist.

What is claimed is:

1. A receiving apparatus to receive a signal modulated by a frequency modulation scheme, using a plurality of receiving antennas, the receiving apparatus comprising:
interference extraction circuitry to extract, from a plurality of reception signals received by the plurality of receiving antennas, interference signals that are frequency components other than frequency components of desired signals at which power is concentrated;
complex weight calculation circuit to calculate a complex weight of each reception signal, on a basis of the same number of the interference signals as the number of the receiving antennas; and
complex weight multiplication and combining circuitry to multiply each of the plurality of reception signals by the corresponding complex weight, and combine the reception signals that have been multiplied by the complex weights, wherein
the interference extraction circuitry extracts the interference signals, on the basis of a frequency pattern of the desired signals of a known sequence included in the reception signals.

2. The receiving apparatus according to claim 1, wherein
the receiving apparatus comprises a plurality of the interference extraction circuitry and a plurality of the complex weight calculation circuitry,
the plurality of interference extraction circuitry extract the interference signals that are frequency components in different ranges,
the plurality of complex weight calculation circuitry are individually connected to different ones of the interference extraction circuitry, and calculate the complex weights on the basis of the interference signals extracted by the connected interference extraction circuitry, and
the receiving apparatus further comprises
complex weight selection determination circuitry to select a complex weight corresponding to each reception signal, from a plurality of the complex weights calculated by the plurality of complex weight calculation circuitry, and outputs the selected complex weights to the complex weight multiplication and combining circuitry.

3. The receiving apparatus according to claim 2, wherein
at least one of the plurality of interference extraction circuitry extracts the interference signals that are frequency components corresponding to delayed waves, on the basis of the frequency pattern.

4. The receiving apparatus according to claim 1, wherein
the interference extraction circuitry performs, on known sequence sections of the reception signals that have been space-time block coded and modulated by the frequency modulation scheme, inverse modulation processing of the space-time block coding, frequency-converts channel estimate values obtained and then removes DC components, and extracts the interference signals on the basis of the frequency pattern.

5. The receiving apparatus according to claim 2, wherein
the interference extraction circuitry performs, on known sequence sections of the reception signals that have been space-time block coded and modulated by the frequency modulation scheme, inverse modulation processing of the space-time block coding, frequency-converts channel estimate values obtained and then removes DC components, and extracts the interference signals on the basis of the frequency pattern.

6. The receiving apparatus according to claim 3, wherein
the interference extraction circuitry performs, on known sequence sections of the reception signals that have been space-time block coded and modulated by the frequency modulation scheme, inverse modulation processing of the space-time block coding, frequency-converts channel estimate values obtained and then removes DC components, and extracts the interference signals on the basis of the frequency pattern.

7. The receiving apparatus according to claim 1, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

8. The receiving apparatus according to claim 2, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

9. The receiving apparatus according to claim 3, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

10. The receiving apparatus according to claim 4, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

11. The receiving apparatus according to claim 5, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

12. The receiving apparatus according to claim 6, comprising
desired signal frequency determination circuitry to determine frequencies of a desired signal in a data section of a signal obtained from a signal obtained by demodulating the signal modulated by the frequency modulation scheme or a signal obtained by decoding error correction, wherein
the interference extraction circuitry extracts the interference signals from the data sections, on the basis of the frequencies of the desired signal in the data section determined by the desired signal frequency determination circuitry,
the complex weight calculation circuitry calculates the complex weights on the basis of the interference signals in the data sections extracted by the interference extraction circuitry, and
the complex weight multiplication and combining circuitry multiplies the data sections of the plurality of reception signals by the corresponding complex weights, and combines the reception signals that have been multiplied by the complex weights.

13. A transmitting apparatus, comprising:
known sequence generation circuitry to generate a known sequence to be multiplexed with a data sequence;
multiplexing circuitry to multiplex the data sequence and the known sequence; and
modulation circuitry to modulate, by a frequency modulation scheme, a signal into which the data sequence and the known sequence are multiplexed, wherein
the known sequence generation circuitry generates: the known sequence in which at least three temporally continuous symbols after modulation by the frequency modulation scheme do not coincide in frequency at which power is concentrated; or the known sequence in which power is concentrated at one specific frequency when signals transmitted from a plurality of transmitting antennas are superimposed together at a receiving apparatus.

14. The transmitting apparatus according to claim 13, comprising
space-time block encoding circuitry to encode the signal that has been modulated by the frequency modulation scheme, using a space-time block code, wherein
the known sequence generation circuitry generates the known sequence in which temporally adjacent symbols or blocks after encoding using the space-time block code do not coincide in frequency at which power is concentrated.

15. A transmission method, comprising:
generating a known sequence to be multiplexed with a data sequence;
multiplexing the data sequence and the known sequence; and
modulating, by a frequency modulation scheme, a signal into which the data sequence and the known sequence are multiplexed wherein
generating the known sequence includes generating: the known sequence in which at least three temporally continuous symbols after modulation by the frequency modulation scheme do not coincide in frequency at which power is concentrated; or the known sequence in which power is concentrated at one specific frequency when signals transmitted from a plurality of transmitting antennas are superimposed together at a receiving apparatus.
